(19) United States
(12) Patent Application Publication
(10) Pub. No.: US 2009/0164467 A1
(43) Pub. Date: Jun. 25, 2009

(54) Ice recognition function to override mobile device lock code

(75) Inventor: Vesa H. Ala-Lahti, Kangasala (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/004,835

(22) Filed: Dec. 20, 2007

(51) Int. Cl. G06F 17/30

(52) U.S. Cl. 707/8; 707/E17.007

(57) ABSTRACT

An apparatus includes a data processor; a user interface; and a memory that stores data representing a contacts database. The contacts database contains a plurality of entries, where each entry has a plurality of fields including at least a name field and a contact field storing information indicating how an entity identified in the name field may be contacted. The data processor is configurable to respond to the apparatus being currently locked by a lock code to prompt a user via the user interface to enter the lock code and, if the user instead enters a predetermined text string that indicates the user wishes to obtain information descriptive of an entity to be contacted in case of an emergency, the data processor presents the user, via the user interface, with only that entry or those entries from the contacts database that are associated with the predetermined text string. The text string may be “ICE” (in case of emergency).

### TECHNICAL FIELD

The exemplary and non-limiting embodiments of this invention relate generally to communication systems, methods, devices and computer programs and, more specifically, relate to techniques for performing emergency-type calling from a mobile device or phone, such as a cellular phone.

### BACKGROUND

ICE (In Case of Emergency) is becoming a de facto standard for using a phone book (contacts) of a mobile communication device (e.g., a mobile phone, also referred to herein as user equipment (UE)) to store the name and number of a person who should be contacted in the case of an emergency.

As is presently known, on most mobile phones one simply need to select ‘Contacts’, then select ‘Add New Contact’, then enter the letters ‘ICE’ next to the name, followed by the telephone number of the named person. It is recommended that both daytime and evening numbers be entered where possible. In the event of an emergency an emergency responder and/or hospital personnel can then readily determine a person to contact, assuming that the patient has their mobile phone with them.

However, there is problem with conventional ICE usage as presently contemplated, as a user interface feature of most, if not all, mobile phones is an ability for the phone's owner or primary user to enter a secret code, also referred to as a lock code, that prohibits the phone being used to make outgoing calls (except for calls made to an emergency number such as 112 or 911). When locked, the mobile phone may typically also not respond to user inputs to access various phone functions, including a phonebook (contacts) function, thereby ensuring privacy for the user's data. In order to access the phone functions the user may typically be prompted to enter the lock (unlock) code. However, and as can be appreciated, if the phone is locked then an emergency services responder or some other care provider cannot access the ICE-related information that the user has previously stored in the phone, and cannot call the ICE contact person. If one assumes that the user may be incapacitated or non-responsive, and thus cannot unlock the phone or provide the lock code to the others, then the ICE feature is defeated and of no use.

An alternative scenario is for the user to never lock the phone, thereby ensuring that the ICE-related information is always available. This is not, however, a satisfactory solution, as many users benefit from the ability to lock and unlock their phone.

### SUMMARY OF THE EXEMPLARY EMBODIMENTS

In accordance with a first aspect of the exemplary embodiments of this invention a method includes, in response to receiving a predetermined text string from a user input of a communication device, determining if the communication device is currently locked by a lock code; if the communication device is currently locked, presenting with a user output a list of only those entries from a contacts database that are associated with the predetermined text string; and upon selection of an entry from the presented list, originating a call to a corresponding phone number.

In accordance with another aspect of the exemplary embodiments of this invention a method includes, in response to a communication device being currently locked by a lock code, prompting a user to enter the lock code; determining if the user enters a predetermined text string that is not the lock code; and if it is so determined, presenting the user with a list of only those entries from a contacts database that are associated with the predetermined text string.

In accordance with a further aspect of the exemplary embodiments of this invention there is provided a computer-readable memory medium that stores program instructions, the execution of which results in operations that comprise, in response to a communication device being currently locked by a lock code, prompting a user to enter the lock code; determining if the user enters a predetermined text string that is not the lock code; and if it is so determined, presenting the user with a list of only those entries from a contacts database that are associated with the predetermined text string.

In accordance with a further aspect of the exemplary embodiments of this invention there is provided an apparatus that includes a data processor; a user interface; and a memory that stores data representing a contacts database. The contacts database comprises a plurality of entries, where each entry comprises a plurality of fields including at least a name field and a contact field storing information indicating how an entity identified in the name field may be contacted. The data processor is configurable to respond to the apparatus being currently locked by a lock code to prompt a user via the user interface to enter the lock code and, if the user instead enters a predetermined text string that indicates the user wishes to obtain information descriptive of an entity to be contacted in case of an emergency, the data processor presents the user, via the user interface, with only that entry or those entries from the contacts database that are associated with the predetermined text string.

In accordance with a further aspect of the exemplary embodiments of this invention there is provided an apparatus that includes interface means for presenting information to, and for receiving information from a user; means for storing data representing a contacts database, the contacts database comprising a plurality of entries, each entry comprising a plurality of fields, the plurality of fields comprising at least a name field and a contact field storing information indicating how an entity identified in the name field may be contacted; means configurable to respond to the apparatus being currently locked by a lock code for prompting the user via said interface means to enter the lock code; and means, responsive to the user entering a predetermined text string that indicates the user wishes to obtain information descriptive of an entity to be contacted in case of an emergency, for presenting the user via said interface means with only that entry or those entries from the contacts database that are associated with the predetermined text string.

The text string may be “ICE” (in case of emergency).

### BRIEF DESCRIPTION OF THE DRAWINGS

The foregoing and other aspects of the exemplary embodiments of this invention are made more evident in the following Detailed Description, when read in conjunction with the attached Drawing Figures, wherein:

FIG. 1 is a block diagram of a device that is suitable for practicing the embodiments of this invention.

FIG. 2 shows one possible exemplary format of an entry in a Contacts database shown in FIG. 1, the entry including a field for indicating that a named entity in the entry is one to be contacted in case of an emergency.

FIGS. 3 and 4 each depict a logic flow diagram that illustrates a method, and the result of execution of computer program instructions, by the data processor shown in FIG. 1.

### DETAILED DESCRIPTION

The use of the exemplary embodiments of this invention overcomes the problem that was discussed above.

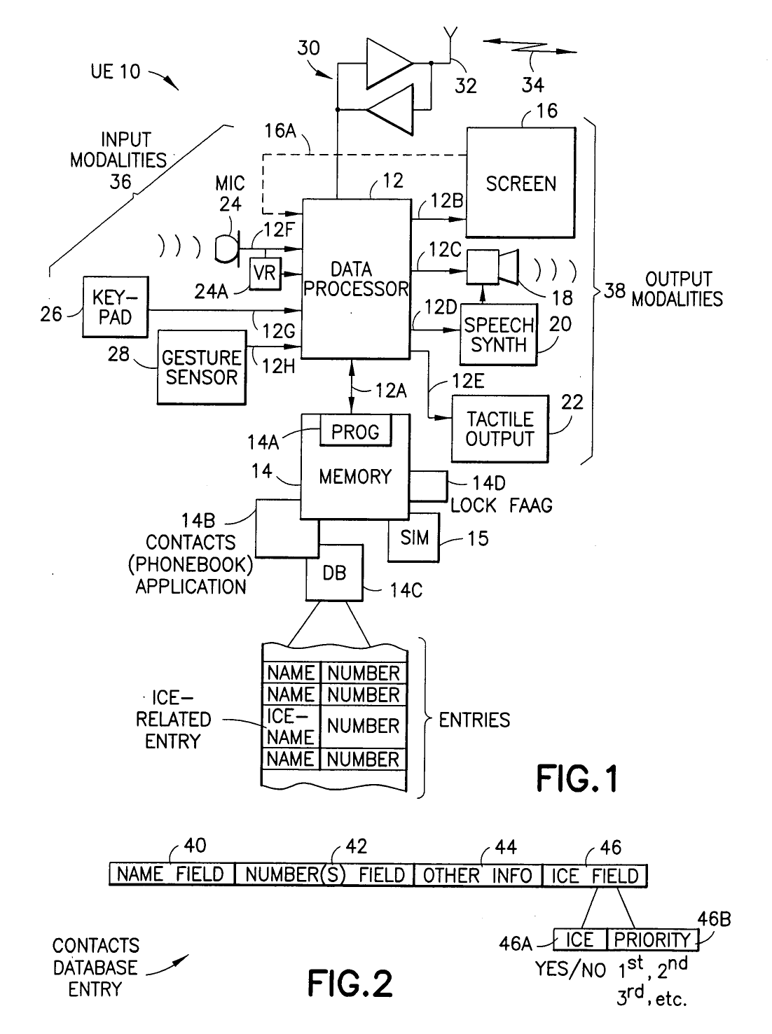

Reference is made to FIG. 1 for illustrating a simplified block diagram of an exemplary embodiment of an electronic device 10, also referred to as a UE, that is suitable for use in practicing the exemplary embodiments of this invention. In FIG. 1 the UE 10 includes a data processor 12 that is coupled through a bus 12A with a memory 14 that stores a program (PROG) 14A of instructions that are executable by the data processor 12. The UE 10 may further include a plurality of input and output devices and subsystems, referred to herein also as input modalities 36 and output modalities 38. As exemplary output devices there may one or more of a visual display screen 16, such as an LCD or a plasma display screen, an acoustic output transducer such as a loudspeaker 18, a speech synthesis subsystem 20 having an output that can be played through the loudspeaker 18 (or through another acoustic output transducer), and a tactile output device or transducer 22, such as a vibratory device (e.g., a piezoelectric transducer). These output devices are coupled to corresponding output paths 12B, 12C, 12D and 12E from the data processor 12. As exemplary input devices there may one or more of an acoustic input transducer such as a microphone 24, an associated speech or voice recognition function (VR) 24A, a keypad or keyboard 26 and a gesture sensor 28, such as a device that is responsive to a rotation about at least one axis and/or to a force applied by a user's finger or stylus, such as when making a tapping gesture. These input devices are coupled to corresponding input paths 12F, 12G and 12H to the data processor 12. If the screen 16 is a touch-sensitive screen then there may also be an input 16A from the screen 16 to the data processor 12. In this case the input to the data processor may represent activation of a virtual key or button by the user, as opposed to the use of the keypad/keyboard 26 where the input signal may represent activation of a physical key or button (such as an alphanumeric key or a physical ‘soft’ key or button). The microphone 24 may be coupled with the speech recognition functionality of the UE 10 (the VR 24A) whereby a word or words spoken by the user can be interpreted by the data processor 12 as representing a command.

It should be appreciated that the data processor block 12 may actually comprise a number of circuit types, in addition to a data processor per se, such as analog-to-digital converters and digital-to-analog converters, that support the operation of the various input modalities 47 and output modalities 48.

In the exemplary embodiments the UE 10 has user communication capabilities, and includes a suitable transceiver 30, such as a radio frequency transceiver coupled with at least one antenna 32 for conducting wireless communications through a bidirectional radio frequency link 34 (e.g., a link to a cellular communication network, or a low power radio frequency link such as a Bluetooth™ link). In other embodiments the transceiver 30 may be optically based and may then include suitable optical source and detector components, such as an infrared emitter and an infrared detector.

It should be noted that the various input modalities 36 and output modalities 38 are exemplary, and not all may be present in a given implementation. For example, the exemplary embodiments of this invention may be used with just the display screen 16 and the keypad/keyboard 26, or with just the display screen 16 if the screen is touch sensitive to permit the user to enter information and commands. In general, those input modalities 36 and output modalities 38 that are actually present in a given embodiment represent a user interface (UI) of the UE 10.

The PROG 14A is assumed to include program instructions that, when executed by the data processor 12, enable the UE 10 to operate in accordance with the exemplary embodiments of this invention, as will be discussed below in greater detail.

In general, the various embodiments of the UE 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless or wired Internet access and browsing, as well as portable units or terminals that incorporate combinations of such functions.

The exemplary embodiments of this invention may be implemented by computer software executable by the data processor 12, or by hardware, or by a combination of software and hardware (and firmware).

The memory 14 may be of any type suitable to the local technical environment and may be implemented using any suitable data storage technology, such as semiconductor-based memory devices, flash memory, magnetic memory devices and systems, optical memory devices and systems, fixed memory and removable memory. The removable memory may be embodied in a subscriber identity module (SIM) 15. In general, the SIM 15 includes a computer-readable memory medium that is configurable to be inserted within and withdrawn from the user device, such as the UE 10. The data processor 12 may be of any type suitable to the local technical environment, and may include one or more of general purpose computers, special purpose computers, microprocessors, digital signal processors (DSPs) and processors based on a multi-core processor architecture, as non-limiting examples.

The memory 14 is shown as including computer program code that implements a Contacts (phonebook) application 14B and associated contacts database (DB) 14C. The contacts database 14C typically includes a number of entries each having at least a name field and a number (phone number) field. If one of the persons represented by an entry is designated as an emergency contact, then the user will have entered some widely known and predetermined text string (e.g., “ICE”) in conjunction with the text string representing that person's name, and the two text strings are stored together in the name field. The operation of the UE 10 is enhanced in accordance with the embodiments of this invention, as discussed below, to improve the ICE-related usage thereof.

The memory 14 may store a lock flag 14D for indicating a locked/unlocked state of the UE 10. Associated with the lock flag 14D is a stored lock code previously defined by the user, and which is employed by a lock/unlock utility of the program 14A to lock and unlock the UE 10 as the user desires. The general ability to lock and unlock a mobile communication device in conjunction with use of a code is well known and is not further described herein, except to describe in detail how the exemplary embodiments of this invention provide enhancements to the conventional lock/unlock operations.

In accordance with the exemplary embodiments of this invention, if the UE 10 is locked, and if the (emergency situation) user enters the predetermined text string “ICE” in response to a lock code prompt query displayed on the display 16 (e.g., “Enter Lock Code”), the contacts database 14C is accessed and only those entries that are indicated as being ICE-related contacts, e.g., only those entries that contain the text string “ICE” in the name field, are presented to the (emergency situation) user via the user interface of the UE 10. In this manner the (emergency situation) user (e.g., an emergency services responder) can become informed of the one or more ICE contacts. At this point the (emergency situation) user can originate a call to an ICE contact. This procedure can be arranged such that the UE 10 considers the number associated with an ICE contact to be an emergency number, and may then permit an outgoing call to be made (originated) to the ICE contact even though the UE 10 is still technically in a locked state (as the actual lock code was not entered). Alternatively, the call can be originated to an ICE contact presented to the (emergency situation) user from another phone. In either case, the result of entering “ICE” in response to the lock code prompt results in a call being originated to an ICE contact entity previously designated.

For example, when the “ICE” string is entered the UE 10 displays (or otherwise presents) the ICE contact list as:

ICE mother

ICE father

ICE spouse.

Preferably the string comparison function is not case sensitive, that is, “ICE” and “ice” and “Ice” are all viewed equivalently.

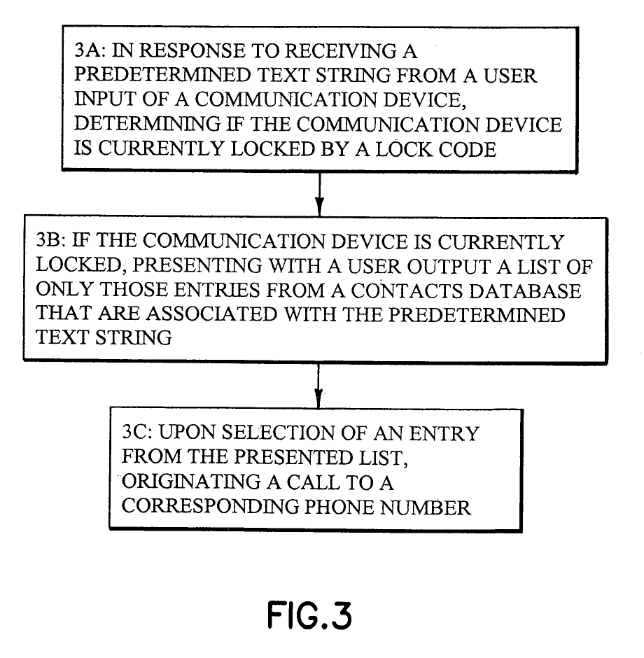

Note that the description thus far has assumed that the ICE text string is stored in association with the contact name text string. However, this is not required for operation. For example, in commonly owned U.S. patent application Ser. No. ______, filed ______, Nokia Corporation Docket No.: NC54987US, Harrington & Smith, PC Docket No.: 857.0046.U1(US), by Antti A. Vainio and entitled “Improved Handling, Management and Creation of ICE Contacts”, there is described a technique to store the ICE designation in a field separate from the name field, as shown in FIG. 2. In FIG. 2 an entry in the phonebook (contacts database 14C) includes at least a name field 40 (normally for indicating a name of a person, but more generally for indicating the name of any entity that can be contacted), a contact number(s) field 42 (which may include a phone number and/or an email address, or more generally any information needed to contact the entity in the name field 40), and other information fields 44, such as fields that store address information, the person's title, etc., as is conventional. The entry also includes an ICE field 46 that includes at least one bit for indicating whether the entry represents an ICE contact (e.g., the bit is set to “1”) or a non-ICE contact (e.g., the bit is set to “0”, which may be the default setting). The ICE field 46 may also include one or more bits for encoding an ICE priority (e.g., 1^{st}, 2^{nd}, 3^{rd}, etc., corresponding to, for example, ICE1, ICE2, ICE3, etc.)

It should thus be appreciated that the ICE designation may be provided and represented in other ways, i.e., other than including the text string “ICE” in the name field (either preceding the name or following after the name), or providing the separate ICE field (ICE-Y/N and priority) 46 as shown in FIG. 2.

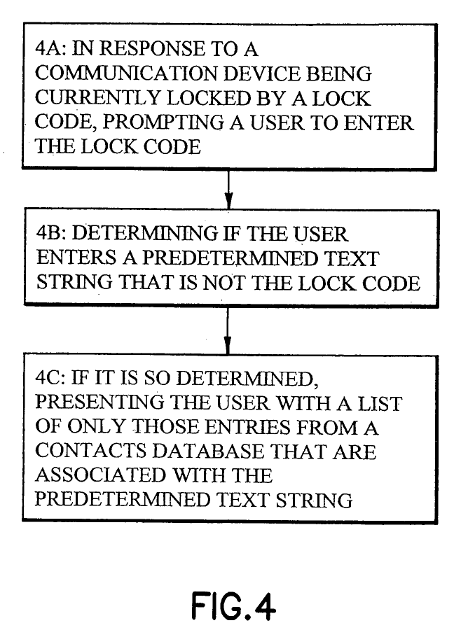

FIG. 3 is a logic flow diagram that illustrates a method, and the result of execution of computer program instructions by the data processor 12 shown in FIG. 1. The method includes (Block 3A), in response to receiving a predetermined text string from a user input of a communication device, (Block 3B) determining if the communication device is currently locked by a lock code; if the communication device is currently locked, presenting with a user output a list of only those entries from a contacts database that are associated with the predetermined text string; and (Block 3C) upon selection of an entry from the presented list, originating a call to a corresponding phone number.

FIG. 4 is a logic flow diagram that illustrates a further method, and the result of execution of computer program instructions by the data processor 12 shown in FIG. 1. The method includes (Block 4A), in response to a communication device being currently locked by a lock code, prompting a user to enter the lock code; (Block 4B) determining if the user enters a predetermined text string that is not the lock code; and (Block 4C) if it is so determined, presenting the user with a list of only those entries from a contacts database that are associated with the predetermined text string.

In the methods of the foregoing paragraphs, where the list identifies at least one contacts database entry associated with an entity to be contacted in case of an emergency, and where the predetermined text string is “ICE”.

In the foregoing methods, and in general, the “list” may comprise but a single entry if the user has designated only a single ICE-related contact, or it may comprise more than one entry if the user has designated a plurality of ICE-related contacts.

The various blocks shown in FIGS. 3 and 4 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims. As but one example, the use of different, similar or equivalent formats for storing the ICE-related information in the contacts database 14C may be attempted by those skilled in the art.

Further, the use of these exemplary embodiments is not limited to use of the “ICE” text string, and neither is it limited to unlocking the phone in response to detection of a predetermined text string for the purpose of calling an emergency contact. For example, the text string may be a user-defined text string that when entered enables access to one or more user-defined functions of the phone, even though the phone is locked. Further by example, the string may be some other predetermined string such as “FYI” (for your information), which when entered into a locked phone displays contact information for the owner of the phone, thereby facilitating returning a lost (and locked) phone to the phone's owner.

However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
in response to receiving a predetermined text string from a user input of a communication device, determining if the communication device is currently locked by a lock code;
if the communication device is currently locked, presenting with a user output a list of only those entries from a contacts database that are associated with the predetermined text string; and
upon selection of an entry from the presented list, originating a call to a corresponding phone number.

2. The method of claim 1, where the list identifies at least one contacts database entry associated with an entity to be contacted in case of an emergency.

3. The method of claim 1, where the predetermined text string is “ICE”.

4. A method, comprising:
in response to a communication device being currently locked by a lock code, prompting a user to enter the lock code;
determining if the user enters a predetermined text string that is not the lock code; and
if it is so determined, presenting the user with a list of only those entries from a contacts database that are associated with the predetermined text string.

5. The method of claim 4, where the list identifies at least one contacts database entry associated with an entity to be contacted in case of an emergency.

6. The method of claim 4, where the predetermined text string is “ICE”.

7. A computer-readable memory medium that stores program instructions the execution of which results in operations that comprise:
in response to a communication device being currently locked by a lock code, prompting a user to enter the lock code;
determining if the user enters a predetermined text string that is not the lock code; and
if it is so determined, presenting the user with a list of only those entries from a contacts database that are associated with the predetermined text string.

8. The method of claim 7, where the list identifies at least one contacts database entry associated with an entity to be contacted in case of an emergency.

9. The method of claim 7, where the predetermined text string is “ICE”.

10. An apparatus, comprising:
a data processor;
a user interface; and
a memory comprising stored data representing a contacts database, the contacts database comprising a plurality of entries, each entry comprising a plurality of fields, the plurality of fields comprising at least a name field and a contact field storing information indicating how an entity identified in the name field may be contacted;
said data processor configurable to respond to the apparatus being currently locked by a lock code to prompt a user via said user interface to enter the lock code and, if the user enters a predetermined text string that indicates the user wishes to obtain information descriptive of an entity to be contacted in case of an emergency, to present the user via said user interface with only that entry or those entries from the contacts database that are associated with the predetermined text string.

11. The apparatus of claim 10, where the predetermined text string is “ICE”.

12. The apparatus of claim 10, embodied in a user communication device.

13. The apparatus of claim 10, embodied in a cellular phone.

14. An apparatus, comprising:
interface means for presenting information to, and for receiving information from a user; means for storing data representing a contacts database, the contacts database comprising a plurality of entries, each entry comprising a plurality of fields, the plurality of fields comprising at least a name field and a contact field storing information indicating how an entity identified in the name field may be contacted;
means configurable to respond to the apparatus being currently locked by a lock code for prompting the user via said interface means to enter the lock code; and
means, responsive to the user entering a predetermined text string that indicates the user wishes to obtain information descriptive of an entity to be contacted in case of an emergency, for presenting the user via said interface means with only that entry or those entries from the contacts database that are associated with the predetermined text string.

15. The apparatus of claim 14, where the predetermined text string is “ICE”.

16. The apparatus of claim 14, embodied in a user communication device.

17. The apparatus of claim 14, embodied in a cellular phone.
